(19) United States
(12) Patent Application Publication
(10) Pub. No.: US 2016/0300195 A1
(43) Pub. Date: Oct. 13, 2016

(54) System and Method for Managing a Product Life Cycle

(71) Applicant: GATES CORPORATION, Denver, CO (US)

(72) Inventors: Robert R. Harvey, Corpus Christi, TX (US); Kim E. Henderson, Castle Pines North, CO (US); Jon McKinley, Corpus Christi, TX (US); Kevin D. Zackowski, Calgary (CA)

(21) Appl. No.: 15/092,848

(22) Filed: Apr. 7, 2016

Related U.S. Application Data
(60) Provisional application No. 62/144,074, filed on Apr. 7, 2015.

(51) Int. Cl. G06Q 10/00

(52) U.S. Cl. CPC G06Q 10/20

(57) ABSTRACT

A method for managing a fluid conduit life cycle comprising inputting a fluid conduit parameter into an operating system, selecting a fluid conduit compatible with the fluid conduit parameter from an inventory data base accessible by the operating system, assigning an identifier to the fluid conduit, assigning a user parameter to the fluid conduit whereby a status can be determined according to the user parameter, selecting a limit for the user parameter, fixing the identifier to the fluid conduit with an interrogatable device, detecting the identifier from the interrogatable device using a detector, transmitting the identifier to the operating system, detecting the user parameter and transmitting it to the operating system, and reporting to a user a life cycle status using the identifier and the user parameter.

### REFERENCE TO RELATED APPLICATIONS

This application claims priority from U.S. provisional application Ser. No. 62/144,074 filed Apr. 7, 2015.

### FIELD OF THE INVENTION

The invention relates to a system and method for monitoring and reporting to a user a product life cycle status using an assigned identifier and a limit of a user assigned parameter.

### BACKGROUND OF THE INVENTION

Various business models have been deployed in which a plurality of users are situated in different locations and a plurality of pieces of equipment are owned and utilized individually by each user. Maintenance of the equipment is carried out by each user. As circumstances require the user contacts equipment operators with regard to equipment in service, inquires where and how the equipment is being used, and so forth, and thus infers the respective operating status of the equipment. Then, based on the current position and operating status thus inferred, a serviceman from each user determines maintenance schedules, and then goes to the site(s) to maintain the equipment in accordance with these schedules.

However, efficient maintenance using this conventional method is difficult and inefficient. That is, investigations by users of sites and the operating states of equipment are time-consuming and labor-intensive. Sites and operating states investigated in this manner are not necessarily accurate. This leads to inefficiencies in that maintenance schedules of low efficiency are established, sites to be visited are overlooked, visits are made to sites which are close to other users stores by servicemen from user stores that are especially far away from these sites, the times at which the maintenance is carried out are too early or too late, and so forth.

Representative of the art is U.S. Pat. No. 6,879,910 which discloses a system and method to precisely monitor remotely located objects. The construction vehicles each contain a GPS apparatus, and various sensors for capturing the states of vehicle parts, and are capable of reporting, as required, the current position captured by the GPS apparatus, and operation information captured by the various sensors to the TMS mail server via the satellite communication system. The TMS mail server and the rental company system are capable of communicating at any time via a communication network between computers. The TMS mail server collects the latest positional information, operation information, and so forth, on the construction vehicles being rented and relays such information in the form of electronic mail, for example, to the rental company system as required or periodically. The rental company system displays construction vehicles by means of marks in the current positions of the construction vehicles on a map represented by map data, or in the form of a list, based on the collected positional information and operation information, on a branch store computer terminal. The system also displays the operating states of rented construction vehicles based on the collected operation information, on the branch store computer terminal.

What is needed is a system and method for monitoring and reporting to a user a product life cycle status using an assigned identifier and a limit of a user assigned parameter. The present invention meets this need.

### SUMMARY OF THE INVENTION

The primary aspect of the invention is to provide a system and method for monitoring and reporting to a user a product life cycle status using an assigned identifier and a limit of a user assigned parameter.

Other aspects of the invention will be pointed out or made obvious by the following description of the invention and the accompanying drawings.

The invention comprises a method for managing a fluid conduit life cycle comprising inputting a fluid conduit parameter into an operating system, selecting a fluid conduit compatible with the fluid conduit parameter from an inventory data base accessible by the operating system, assigning an identifier to the fluid conduit, assigning a user parameter to the fluid conduit whereby a status can be determined according to the user parameter, selecting a limit for the user parameter, fixing the identifier to the fluid conduit with an interrogatable device, detecting the identifier from the interrogatable device using a detector, transmitting the identifier to the operating system, detecting the user parameter and transmitting it to the operating system, and reporting to a user a life cycle status using the identifier and the user parameter.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a schematic of the hardware system.

FIG. 2 is a chart identifying the hose management system components.

FIG. 3 is a chart identifying the survey components.

FIG. 4 is a chart identifying the registry components.

FIG. 5 is a chart identifying the inspection, maintenance and re-certification components.

FIG. 6 is a chart identifying registry components.

FIG. 7 is a chart identifying the rental process.

FIG. 8 is a chart identifying disposal components.

FIG. 9 is a chart identifying the information transfer.

FIG. 10 is a screenshot of the data analysis tool user options.

FIG. 11 is a screenshot of a flexible hose assembly downtime analysis.

FIG. 12 is a screenshot of a flexible hose assembly replacement schedule.

FIG. 13 is a screenshot of a flexible hose spend analysis.

FIG. 14 is a screenshot of a flexible hose assembly incident analysis.

FIG. 15 is a screenshot of the dashboard detail for a monitored product.

FIG. 16 is a screenshot of the dashboard detail for a monitored product.

FIG. 17 is a screenshot of the asset replacement screen.

FIG. 18 is a screenshot of the asset detail page.

### DETAILED DESCRIPTION OF THE PREFERRED EMBODIMENT

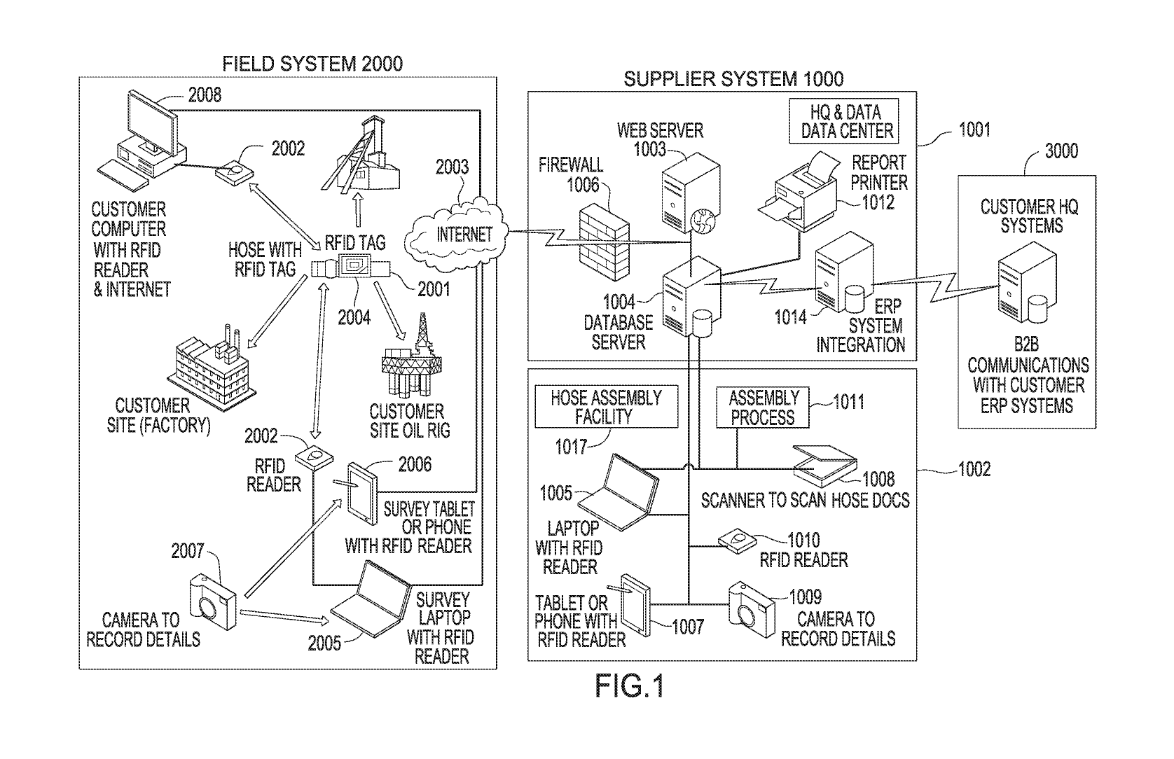

FIG. 1 is a schematic of the hardware system. The inventive system comprises a computer system 1000 for performing information processing, which is in the supplier company facility 1001 and supplier assembly facility 1002 (referred to hereinafter as “supplier company system”); a multiplicity of monitored products 2001 which comprise hose, couplings or other monitored products 2001; and an RFID reader system 2002 that remotely captures the respective digitized information from the monitored products 2001. A monitored product may comprise tubing, hose, pipe, fluid conduits and any other component or device requiring monitoring. Any of the monitored products may also be rigid or flexible.

A supplier representative visits a customer site. The supplier representative is equipped with an RFID reader and/or other device capable of detecting information about the monitored product. RFID readers 2002 and the supplier computer system 1000 are in principle capable of communicating at any time and irrespective of where the RFID readers are located, via the internet 2003. Communication is preferably via wireless communication system that operates irrespective of location subject only to coverage by a suitable data receiving and transmitting system.

Each monitored product contains an RFID chip 2004 which stores information unique to that given product. A barcode may also be used. If an RFID chip is not present on the product, one can be installed by the representative. Each RFID is capable of reporting the current data stored in the chip memory to the RFID reader 2002, 2006, 2005, 2007. The RFID/barcode reader (or device) then reports to the supplier computer system 1000 via the internet 2003. The representative also takes photos and records other pertinent data about the monitored product and its environment.

The supplier web server 1003 and database server 1004 collects the latest RFID transmitted information on the monitored products 2001 and presents the information in the form of display screens to the supplier company system user.

The supplier company system 1000 comprises various devices and computers 1005, 2005 which are either in the field or installed in company facilities 1001, 1002. The system comprises portable information processing devices carried by suppliers representatives for example portable survey tablets 2006 and cameras 2007 which may also comprise smartphones, tablets, PDAs (Personal Digital Assistants) or any other device capable of sending and receiving wireless transmissions. The system configuration as illustrated is only an example, and other configurations can also be adopted. For example, each representative may have to carry multiple reader and communication devices suitable for multiple but dissimilar systems.

Behind the firewall 1006 of the supplier company system 1001, the web server 1003 receives and stores electronic communications that describes the latest information on the monitored products which is sent from the readers and field systems 2000 (referred to as TMS mail hereinafter). “Field system” includes both customer and supplier representative components located remotely from the supplier company facilities.

The database server 1004 receives data stored in the web server 1003 and extracts data representing the latest information on the monitored products. The details of the data stored in this database (referred to as master data hereinafter) will be described subsequently. Upon receiving the data, the database server 1004 uses this data to update the master data related to each monitored product. The database server 1004 is connected, via the supplier company network, to various output devices 1005, 1007 as required. Database server 1004 can also communicate wirelessly via the web server to the field system 2000 devices via the internet. Types of data which can be supplied as phone content to the portable/smart telephones 2006 include all data described elsewhere in this specification.

The database server 1004 first receives a search request with respect to a specific monitored product from any remote device 2005, 2006, 2007, 2008. Thereafter, the database server 1004 assembles the data and creates the requested content on the basis of the latest data, and then transmits the content to the requesting remote device. The requested data may also be output via printer 1012 to hard copy.

Each customer device 2008 may also request and received data from the database server 1004 with respect to certain monitored products. Data is only made available upon receipt of proper access codes from the customer computer 2008 or other requesting computer. Further, the supplier system 1000 can communicate directly with the customer system 3000 via the internet.

Devices 2006, 2007 carried by supplier representatives can be connected as required to the supplier system 1000 via the internet 2003. A business application that supports the external tasks of the representatives is installed in each remote device. In the office of the company, a number of devices including laptops 1005, PDA's 1007, scanners 1008, RFID readers 1010, and cameras 1007 are connected to the database server 1004. An application installed in the database server 1004 is used to perform processing as described herein.

Furthermore, the supplier company system 1000 is connected to a server 1011 of a company assembly facility that carries out assembly, repair, testing and decommissioning of monitored products, and the like.

Information on all the monitored products is centrally managed by the database server 1004 in the supplier company system 1001, and this information is continuously updated by the latest information. Further, this information can be referenced via any remote device via any laptop 2005, PDA 2006 of the representatives. Business decisions and activities can be implemented on the basis of this information.

The supplier system includes integration with an ERP system 1014 for processing cost and financial data for each monitored product. As a result, efficient financial and operational management of all monitored products is made possible. This is because the system makes all data relating to an individual monitored product immediately available for use to promptly inform decisions concerning the capacity and use of the monitored product. The system may also apply a financial analysis of selected parameters as relate to the monitored product.

According to the system of the present embodiment, the supplier representatives are able to respond quickly to customer needs. This is because, as detailed above, it is possible to select an option for a desired monitored product which is compatible with the customer's request and which is advantageous also in terms of application, cost, specifications, and so on. It is possible to check the current state of all monitored products at a given site, for a given customer, for example, by defect, by manufacturer and so on at any time and in any location by using a wireless or hardwired remote device 2002, 2006, 2005, 2008.

According to the system of the present embodiment, it is also possible to carry out appropriate maintenance on monitored products. This is because information relating to the monitored product and its history are immediately available via the network to each remote device. This is highly advantageous since, where monitored products are concerned work is frequently carried out in very remote locations with difficult access.

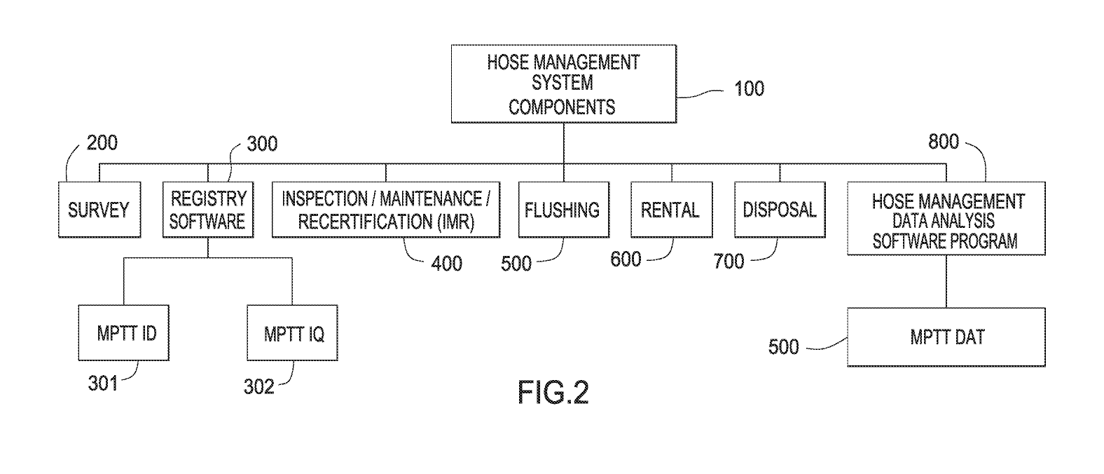

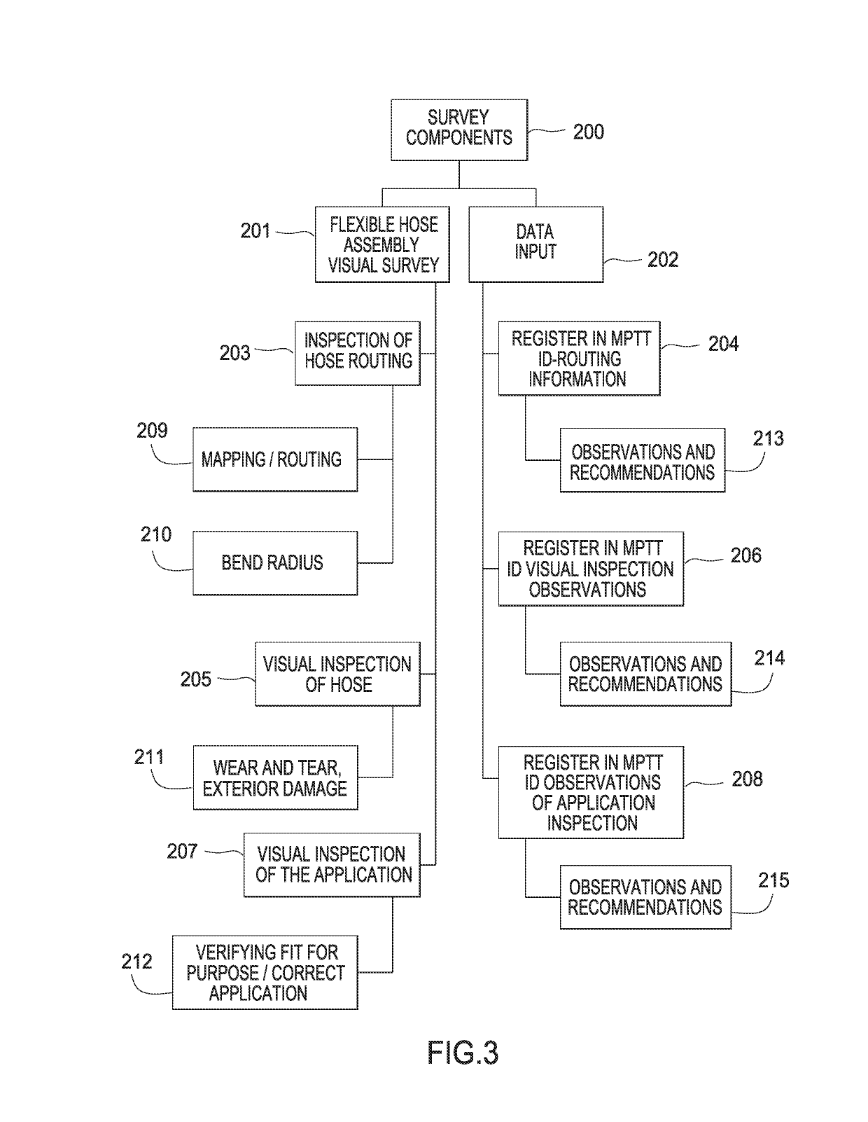

FIG. 2 is a chart identifying the product management system components. The hose management system 100 is a comprehensive flexible monitored product life cycle management system that provides engineered solutions to a user. This specification refers to hose for ease of reference, but it is more widely applicable to any form of fluid conduit, comprising different materials and characteristics.

The system is a comprehensive operational and capital efficiency ERP program that provides a specialized fit for purpose methodology utilizing performance, economic and life cycle trends for hydraulic, industrial and rotary (including oil field, mining and marine application) fluid conduits and hoses. “ERP” generally refers to enterprise resource planning and may comprise budgeting and planning processes which are not the subject of this specification.

The system also comprises data capture tools utilized to examine, measure, test, inspect, certify/recertify, record performance parameters and establish a registry of hoses that provides the database for the analysis. The tools are integrated into the system through hand held clients, electronic control units, condition monitoring hardware, and software applications.

The system is a document control system that provides a complete life cycle and performance history of a monitored product as recorded with supporting documents, certificates of conformance, inspections records, test graphs & certificates, charts, schematics and photographs. The supporting documents included in each hose file and are readily available for web based retrieval from multiple user dashboards both on location where the monitored product is being used and at any customer accessible, secure offsite location.

The system provides the analysis tools and documentation to conduct hazard analysis and maintenance activities that integrate into the end user's management systems. The system assists end users to comply with various industry requirements. While the term “hose” is generally used in the descriptions, this is not by way of limitation since the method may be applied to any monitored product.

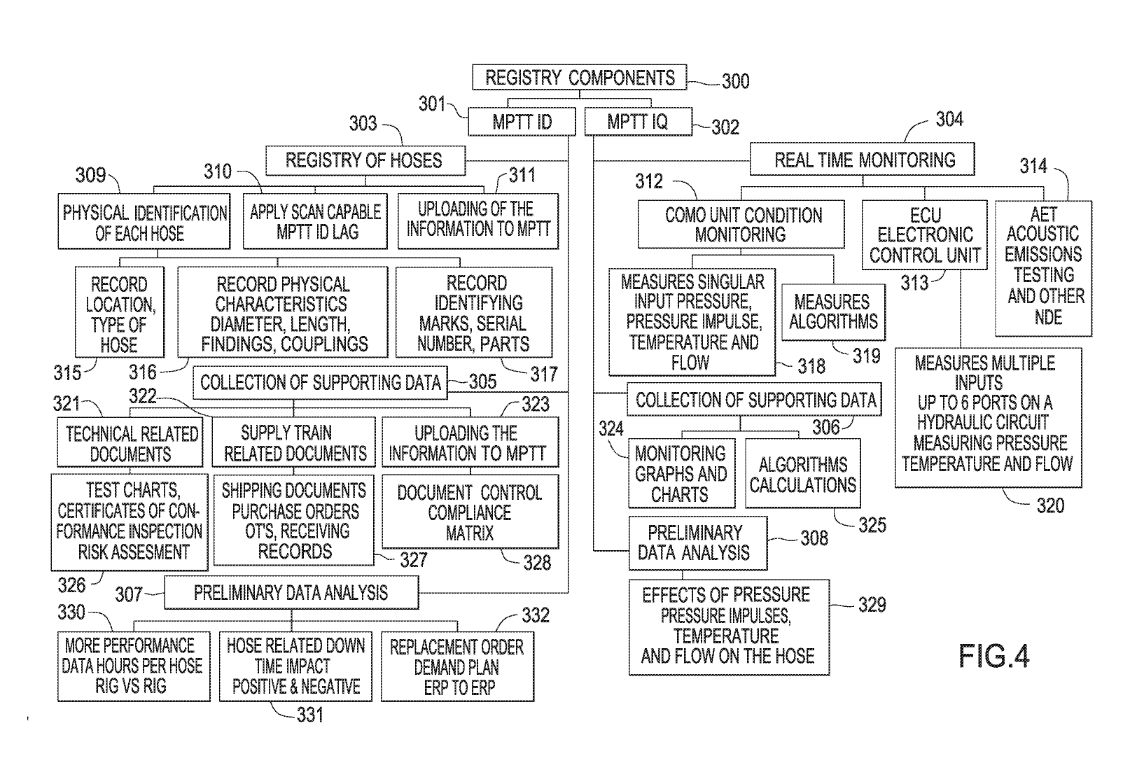

The lifecycle begins when a new hose or other monitored product is ordered by a customer or when an existing customer monitored product is requested to be inspected. This is typically captured in the visual survey 200. Creation of a hose file in the system comprises a visual inspection survey 201 and gathering and input of the survey results and other relevant documents and data 202. This can include, for example, a purchase order detailing the bill of materials and specifications for which the hose is to meet, or, gathering the existing documentation from the customer for a hose already in use which may include the bill of materials and hose specifications. For example, see FIG. 4, steps 322, 327.

The user creates a unique record for the hose by assigning a unique identifier such as a serial number, or, by use of an existing unique identifier or serial number 202, 311. The unique identifier can be any combination of alpha characters, numerals, or keyboard notation (all available QWERTY board symbols including uppercase 1 thru 0) or a combination of all three. The user assigns an RFID tag, barcode, or engraved tag in a manner known in the art and affixes it to the hose, see 310. The user then gathers from the customer other relevant data such as hose owner information, location of use, parent and child assets, hose description, hose construction, hose brand, hose cost, expected life, hazard analysis, and application data. This data is then used to populate fields in the data base, see steps 204, 206, 208, 311, 323.

Physical information can be obtained by the user by inspection of the hose routing 203 and application 207. Routing includes mapping the hose layout and route which includes bend radii 209, 201. Inspection may look for evidence of wear and tear and physical damage 211. The proper application is inspected to verify the purpose and application are correct for that particular hose 212. The information developed for each of the respective steps is input to the system via each step 204, 206 and 208 respectively. The system can also accommodate related observations and recommendations depending on the circumstances, see 213, 214, 215.

These activities commission the hose into the system making it an active record and providing it with a start of life, also known as the birth certificate, see 301, 303 FIG. 4, generally referred to as monitored product tagging and tracking (“MPTT”). FIG. 4 is a chart identifying the registry components.

The supplier/user gathers information from the customer to determine inspection and monitoring parameters based on the customer's operation such as the type of medium or fluid the hose will convey, expected inspection schedules either based on time interval, wear limit, hazard classification, or accounting rules. Inspection regimes are then created in the system for the hose based on the data provided. The database contains configurable checklists and work orders for each hose or group of hoses that share common inspection regime indicators of hose owner, hose location, hose application, and inspection interval.

The new hose records can include a bill of material, purchase order, test certificate, certificate of conformance, test graph, financial information such as cost, quality records such as build sheet, heat numbers, non-destructive examination (NDE) records, images of the hose, ABS, DNV, Lloyds Register, and API license certification records for the manufacturer and supporting vendors, and instructions for use and care are then uploaded into the system. For example, see steps 309, 315, 316, 317. NDE examination techniques may include visual, dye penetrant, ultrasound and x-ray.

This data can be collected from the customer for existing hoses and are likewise uploaded into the system for each hose assembly.

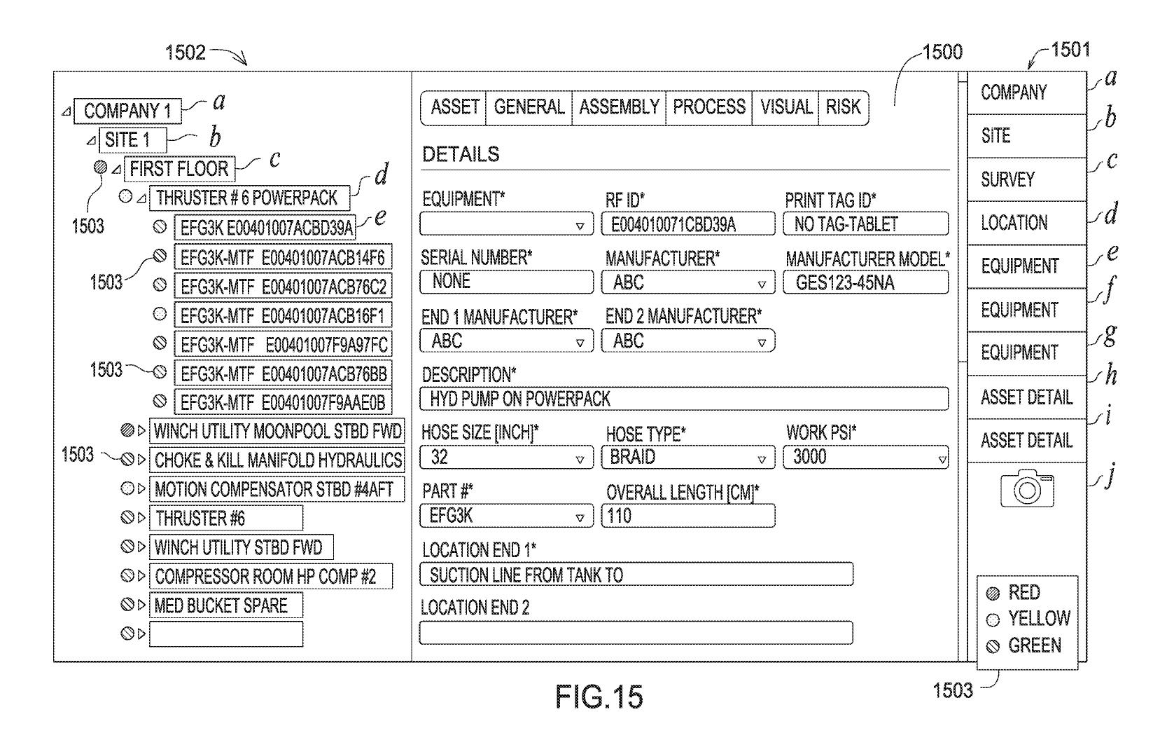

A risk analysis for each hose assembly may be conducted in accordance with “Oil & Gas UK guidelines for the Management of Flexible hose assemblies 2006”, or in accordance with “API 580 requirements for Risk Based Inspection”, or other industry standard as examples. The resulting risk classification is then populated in the corresponding field within the data base, see FIG. 15, portion 1500. This will assist the hose user to determine the appropriate risk mitigation activities to be performed by inspection and testing throughout the life of the hose assembly, see 305 and 307. Hose may also refer to a hose assembly which includes couplings (end connections) and the hose itself.

The hose is also associated with the appropriate financial management system corresponding to the end user's system so the financial aspect of managing the hose can be integrated with the system. The necessary data formats can be created for known back end reporting systems used in, for example, Oracle, SAP, JDE, and other ERP software systems.

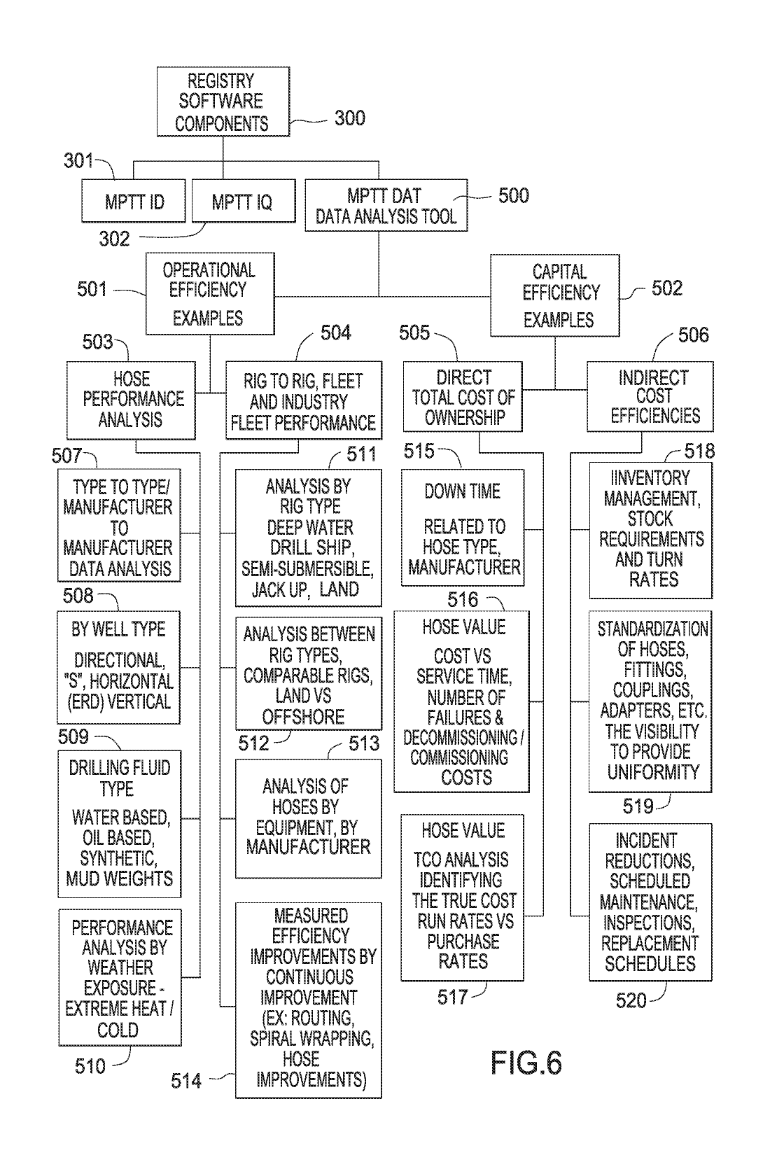

The new hose is then installed, or the existing hose is RFID tagged and scanned into the system and placed in inventory. For example, see 310. This starts the clock for time based interval inspections, wear limit inspections, risk based inspections, or financial thresholds. For example, see 330, 331, 332 and FIG. 6. FIG. 6 is a chart identifying registry components.

FIG. 6 is a chart identifying registry components. The data analysis tool 500 comprises calculations directed to either operational efficiencies 501 or capital efficiencies 502. Under operational efficiencies hose performance 503 and system performance 504 are analyzed.

For the performance analysis 503, a comparison can be drawn between different hose types 507. This would be used to identify strengths and weaknesses between competing hose types and brands. A comparison could be drawn by well type 508. This would quantify the multiple variables between wells such as fluid type, pressure, temperature, flow rate, chemistry and so on. Further information can be developed by comparing drilling fluid type including water based, oil based, synthetic, mud weights, solids content, and so on. Finally, other variables can also be included such as ambient weather conditions 510 in the rig environment.

Also as part of the operational efficiency analysis 501, a comparison can be drawn between rigs and the industry fleet 504. These can include by rig type 511, 512 and hose type 513. It can also include a comparison of efficiency gains brought about by continuous improvement 514.

Capital efficiency examples can also be drawn 502. These include total cost of ownership 505 and other cost efficiencies 506. Total cost includes down time 515. It also includes hose values based upon failures, decommissioning costs and service factor 516, as well as true cost of operation (TCO) analysis based on true cost run rates vs purchase rates 517.

Other cost efficiencies 506 comprise inventory management 518, standardization of parts 519 and incident effects and reduction 520.

The system generates notifications to the end user of the hose for inspection, and maintenance activities. See 324, 325. This is accomplished by sending a system generated email to the customer/end user of the hose in compliance with the inspection and maintenance regimes.

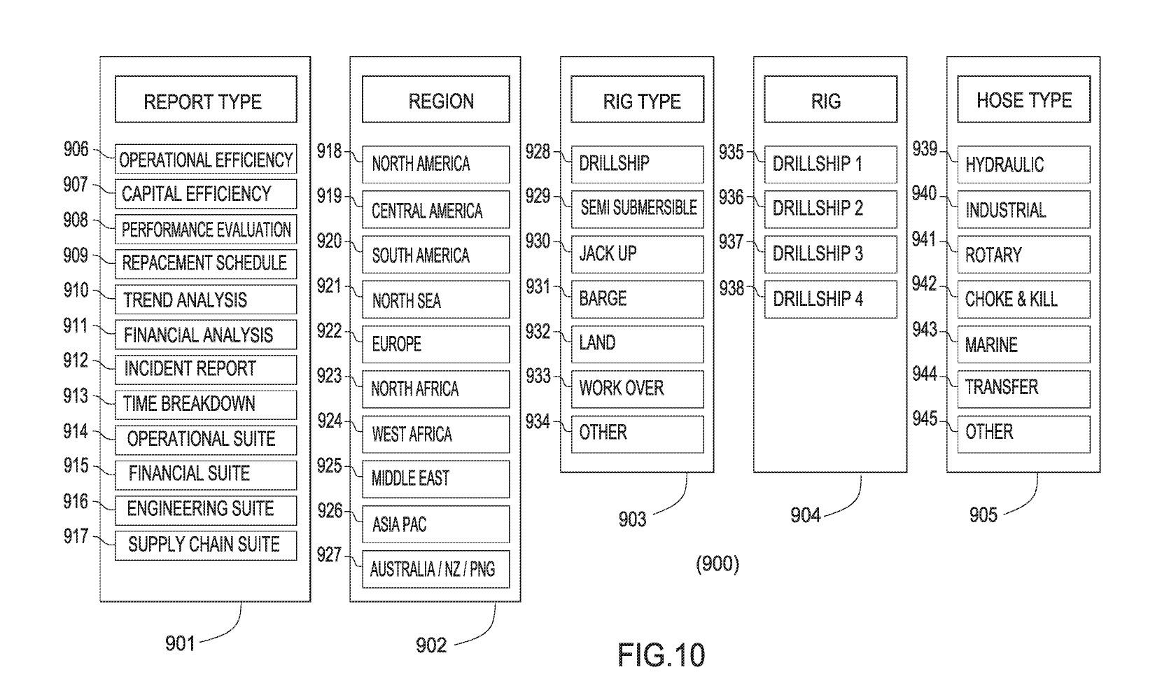

Through dashboard and reporting tools, the system provides individual reporting and dashboard capabilities to management personnel in the following departments, operations, engineering, finance, supply chain, quality, health, safety and environment, and maintenance. See FIGS. 10 through 15.

The system uses a red light/green light/yellow light identification system to notify the customer of the status (within customer or industry defined parameters) of each hose (monitored product). The lights change from steady to flashing when the trend transitions from a positive to negative parameter. The parameters can be time based such as an expected replacement date from the date of install; wear limit based such as exhibiting corrosion, deformation, and damage detected in inspections; risk based such as is classified through the hazard analysis process in both preventive maintenance, and inspection regimes, and revenue based such as reaching a threshold of depreciation for the asset to trigger replacement activities, see 332. FIG. 15 is a screenshot of the detail for each monitored product.

In addition the green, yellow, red indicators on the dashboard commence based on the parameters agreed upon with the customer for time based inspection, time based life expectations, known wear limit inspection or integrity operating window, risk classification changes based on history of equipment, equipment damaging incidents, design factors, exposure rates for probability and consequence of failure data. See FIG. 15.

Other parameters include financial depreciation data, day rate data associated with equipment down time resulting in a time multiplied by dollar value data output, media changes with hydraulic fluids, chemicals, drilling fluids and exposure and application data such as temperature, pulsation, pressure. See steps 330, 331, 304, 306, 308.

The collection and input of data to influence all of the alert indicators is constantly updated through the use of the integrated tools, condition monitoring equipment, inspections updated through hand held clients, and user input updated through the dashboard. See 312. Status of the indicators changes based on the prescribed parameters. Other parameters such as time based and depreciation indicators are calculated by the software system using a prescribed algorithm and the real time status changes the color of the alert indicator from green to yellow to red based on reaching a defined threshold. For example, the threshold can be expressed as a percentage of the total defined threshold. For example, a green indication could be indicated by the threshold being in the 0-50% range, a yellow indication would be in the 51-80% range and a red indication would indicate a threshold for the data parameter in the 81-100% range.

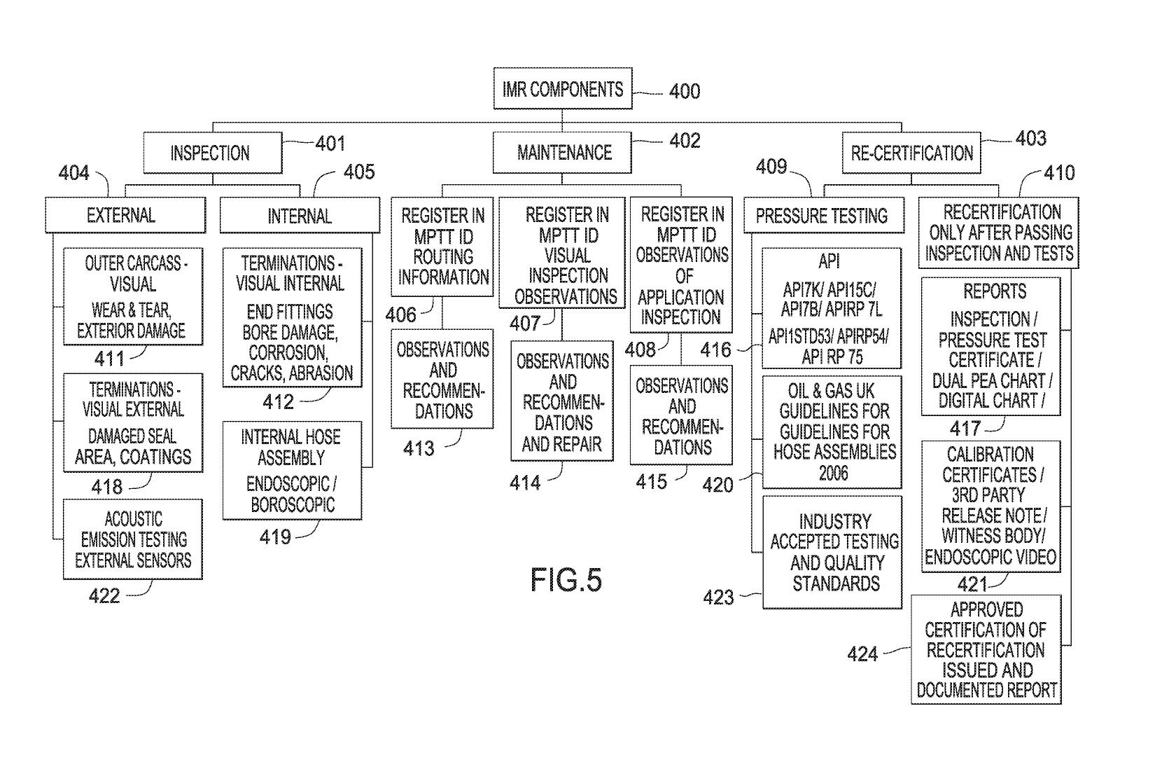

As an example, the alert indicator for the financial depreciation of the hose might be green because the asset was expected to be depreciated over 10 years and the asset is in year one of use (10%), while the alert indicator might be red for the expected life of the hose because it was expected to be exposed to 1000 pulsations from the time of install to decommissioning and condition monitoring equipment has measured 900 pulsations in year one (90%). See 329. The information provided allows the owner of the hose to adjust the inspection, maintenance, or replacement intervals as required. See steps 313, 314, 320 and FIG. 5.

FIG. 5 is a chart identifying the inspection, maintenance and re-certification components. During the inspection step the hose is inspected externally 404 and internally 405. The external inspection includes the outer carcass 411 for obvious defects like abrasions, corrosion, tears, cracks and holes. Terminations such as couplings, flanges and weld nipples are also inspected 418. Internal inspections also consider the carcass and terminations, 412, 419.

In the first step a customer enquiry is received 10. Enquiries can be received either directly from customers who have identified a requirement for inspection, maintenance, or recertification (IMR) for a given hose assembly, or through a previous contact with that customer.

Following receipt of the IMR inquiry, a job assessment is conducted. Through discussions with the customer the general IMR requirements are established. These include, project scope; customer asset, on/off shore, technical data on hoses (type, location), timing; risk review; HSE job and location issues, customer HSE system/expectations, inductions; resource requirement; manpower, competency/training, and equipment; personnel: skills required, visas, certifications, training; logistics; how will equipment and manpower arrive on site, customs requirements; security assessment; security risk at location; competition; who are the other bidders for the project; environment: regulations and customer requirements at the project location; waste management processes; testing location: site utilities (power, water, air) lifting; legal: review supply agreement, embargoed countries, insurance, liabilities, and disclaimers. At the start of all projects a project file is created to collect all relevant project information which will be used through to completion of the project or to assist in lost order reviews. The project file can also be used as reference when bidding on future projects.

Upon completion of the job assessment, the next step is costing, quoting and order acknowledgement. Once the project scope has been established a project manager is appointed. The project manager coordinates the development of the project cost. The project manager determines a price through analysis of a number of factors including competitive pressures, timing, customer drivers and location. If it is decided to bid on the project, a quotation is developed and submitted using a standard global format. The global format includes a specific scope for the project, terms and conditions along with an identification of what the customer is expected to provide. Once the approved order has been received from the customer a copy of the hose handling guidelines is provided to assist the customer in delivering the hose assemblies to the test site.

The next step is IMR resource scheduling. Once an order is confirmed to the customer the project manager identifies the internal resources required to execute the project to the agreed timing schedule. The resources required are identified and reserved. A project plan is developed based on the job assessment and quotation phases. Initial on-boarding is done with personnel assigned to the job, roles and responsibilities are assigned, competencies/training verified.

The next step is IMR resource preparation and mobilization. In this step the IMR equipment is prepared for shipment to the test site. As part of this preparation, checks are made on the condition of the equipment, including that the correct certifications are in place, tools and fixtures are present, and verification that the IMR modules and process meet the regulations and customer requirements. The logistics are finalized and customer contacts for the site location are established to ensure the equipment arrives at the test site on time.

The next step is IMR Equipment Set Up and Commissioning. Once the IMR equipment and team have arrived at the test site, a site risk assessment is conducted, risk, HSE and environmental information reviewed in job assessment are used to validate or revise the job set-up. The equipment is unpacked, setup and checked so IMR activity can commence. Checks are also conducted on the equipment and facilities provided by the customer. At the same time inductions, contacts, management of change communication and emergency procedures are established.

The next step is receipt, preparation and identification of hose assemblies. The test hoses are received at the test site. At the time of receipt a unique identifier is recorded for each monitored product. The delivery and condition of the hoses (monitored product) is recorded and communicated to the customer. The number hoses and type are compared to the original quotation to ensure project scope has not changed. The test schedule is confirmed with the customer so that a third party can witness the test if required.

The next step is cleaning of hose assemblies. The test pieces are cleaned both internally and externally including the end fittings. The cleaning process includes high pressure water jetting and manual cleaning of the end fittings. Care must be taken to collect and recycle the cleaning fluids.

The next step is inspection. A visual inspection for damage, corrosion, hose/coupling integrity is made of the external and internal surfaces of the hose along with the end fittings. The location, size and nature of the damage is recorded using standard documentation. If there is obvious damage, degradation or missing accessories the customer is informed. If hoses fail the inspection, the customer is informed.

The next step is pressure testing. Hose assemblies are connected to the IMR test equipment and tested in accordance with the original manufactures recommendations and supplier testing procedures or other relevant published industry standards. Prior to the pressure test the customer is informed of the increased risks associated with the pressure testing operation and the test site is cordoned off. Upon completion of a successful test, the hose assembly is issued a successful test certification and is considered “recertified” as meeting manufacturer or industry standards. For hose assemblies that have not been identified through electronic means (bar code, RFID) they are then uniquely identified with the RFID tag or bar code in preparation for return of the hose assembly to operation.

The next step is repair. If there is repairable minor non-structural damage to the hose cover or the end fittings repairs are typically made on site. Complete couplings may be replaced. If repairs are required, the customer is informed and a separate quotation is submitted. Repairs take place after the tests show that the monitored product holds pressure and can be returned to field operations.

The next step is return, disposal or shipping of tested hose assemblies. On completion of the IMR process, hoses assemblies are returned to the customer. Hose assemblies which are revalidated are tagged capped or plugged and returned in the manner as received. Hose details are entered into the database. Hoses which have failed revalidation are also returned to the customer for their disposal and recorded as “decommissioned” and withdrawn from service as noted.

The next step is test report and certificates. An inspection report for each hose assembly is completed and provided to the customer recorded and all reports and related test certificates uploaded into the hose, and rig, folder. If the hose assembly is tested at a supplier facility, the test reports are returned with the hose assembly to the customer.

The next step is demobilization. When IMR activity is complete, all equipment is checked, inventoried and packed.

The next step is customer sign-off. The customer is informed that the project has been completed. Confirmation sign-off is received from the customer that they are satisfied that the job has been completed per the agreed scope and the site and equipment has been returned in an acceptable condition. In addition, the customer is made aware of the next IMR due date.

The next step is project review. This review seeks to understand the following if the job was performed successfully, and if not why not? Were risk properly identified in the job assessment and were mitigation efforts successful? Was the job completed on time and on budget? Were there any equipment maintenance or HSE issues? Were there any personnel, competency, training, communication issues? Was the process effectively followed or does it need changing? In addition to the review a case study is generated for the project and added to the case study library.

The end user benefits from the ability to use the data to make adjustments in parameters to get the optimum use and value from the monitored product. The objective of the system is to avoid pushing the monitored product beyond acceptable limits or replacing the monitored product too frequently creating either unnecessary costs, or unnecessary risks.

As hoses near the thresholds set by the parameters emails generated by the system are sent to the owner of the hose and other personnel responsible for managing, inspecting, maintaining, or replacing the hose assembly. Based on roles and permissions each individual or group of individuals will have access to different levels of data based on their defined role. Management personnel will have access to all data concerning the hose, while a maintenance mechanic working for the owner of the hose might be able to see only the time intervals and expected wear limits in reports in their dashboard.

Once the hose assembly approaches and exceeds thresholds, or mitigation and intervention activities indicate that the hose requires replacement email alerts are sent out and hose quotes and/or purchase orders are generated in the system and submitted electronically through the supplier's ERP system to generate replacement activities. Once replacement is agreed upon by the customer the hose is scheduled for decommissioning/un-install, ie, death certificate.

The hose is then disposed of in accordance with all applicable regulations and records are uploaded into the system by the use of the integrated tools (hand held and stationary clients) by the supplier personnel. The hose data remains in the system for future reference but all alerts indicators are deactivated for the decommissioned hose.

The replacement hose is then created in the system, commissioned, installed, evaluated, and monitored based on the same lifecycle management model as the previous hose. Although the prior hose is decommissioned the data from that hose remains in the system for multiple reasons: compliance with regulatory record keeping thresholds, historical data to show trending in the reporting system for pieces of equipment, defined data analysis groups, and performance within a larger system of other components, for root cause analysis data should incidents occur with similar hoses and applications, and for financial spend and cost of ownership documentation and analysis.

In particular, the system provides a systematic evaluation methodology that delivers financial, economical, performance and incident related data analysis for the monitored product. These analysis include life cycle documentation including certificate of conformance, certificate of hydrostatic test, test graphs, inspection documentation. It also includes order processing documentation such as quotes, purchase orders, delivery tickets, returned tickets, and transportation documents. It also provides predesign and install hazard analysis, commission and install records. It also provides incident/failure documentation including root cause analysis/tap root report plus investigation reports.

Disposal documentation is provided including decommission and un-install records. Also included are validation documents stating proper disposal.

Performance analysis are provided based on time intervals, wear, and damage noted in inspection activities. These formats include hose vs same hose, hose vs replacement hose, hose vs comparable hose, hose vs hose by manufacturer, rig vs rig hose performance (using all evaluation criteria), hose vs industry performance trend (using all evaluation criteria). Also included is hose performance by well type; directional, “S”, horizontal, vertical and multiple entry. It also includes hose performance by drilling fluid type such as oil base, water base, high weight (SG) and low weight (SG); hose performance offshore vs land (using all evaluation criteria), hose performance by environment (Cold/Hot Weather, Wet/Dry, UV exposure), hose performance by geographic area (using all evaluation criteria), hose performance by optimized vs non optimized rig handling capabilities.

Other data may include operational (performance) efficiency displayed based on agreed upon parameters with the customer. The variable can include hose related down time by hose, manufacturer, rig or environment. Hose management evaluation to maximize time in service through performance evaluation criteria. These include operational analysis based on performance/time in service; by manufacturer; hose vs hose total cost of ownership model; by inventory stock requirements; by well type; drilling fluid type; rig type; by environment.

Planned hose replacement is based upon just-in-time hose performance evaluation. The goal is to choose the right time to replace the hose to maximize operational and capital efficiency and time in service without risking failure. For example: Determining a replacement schedule based on average trend analysis in-service life with set minimum parameters—12 month trended life span (as determined by data), planned replacement at 11 months maximizing cost efficiency while minimizing operational inefficiency by avoiding hose failure.

Capital efficiency is also a consideration of the system. The capital efficiency is displayed and integrated into the financial ERP system based on compatibility of type of ERP system used by the customer and defined and agreed upon parameters for financial thresholds and fields to be populated. The financial analysis may be based on performance/time in service, by hose vs hose by manufacturer, by hose vs hose total cost of ownership model, by inventory stock requirements, by well type, by drilling fluid type, by rig type, or by environment.

Inventory management is accomplished by system generated emails sent to users. Inventory turn rates are selected by the user. Demand planning is based on an analysis of use and a predetermined hose replacement schedule. This ties to replacement hose (JIT) which means a customer has lower inventory on hand. The basis is understanding what hoses are required and turn rates/lead times required to deliver capital efficiency targets.

In addition to creating a traceable life history for a hose assembly, the system can also set up and track inspection, maintenance and recertification for a hose assembly.

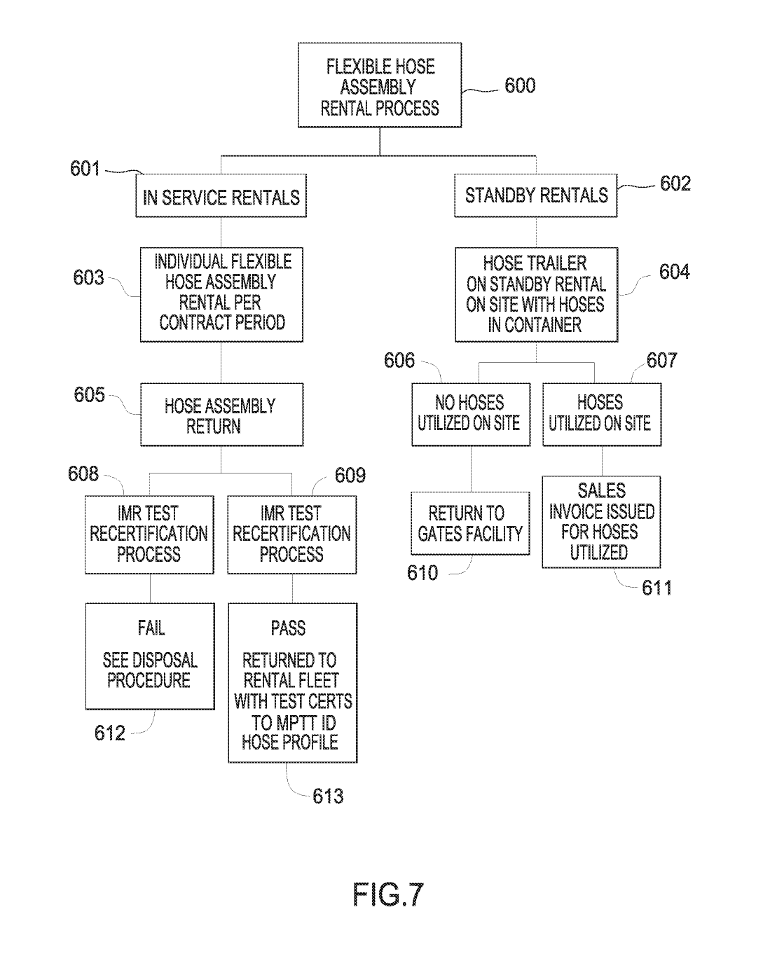

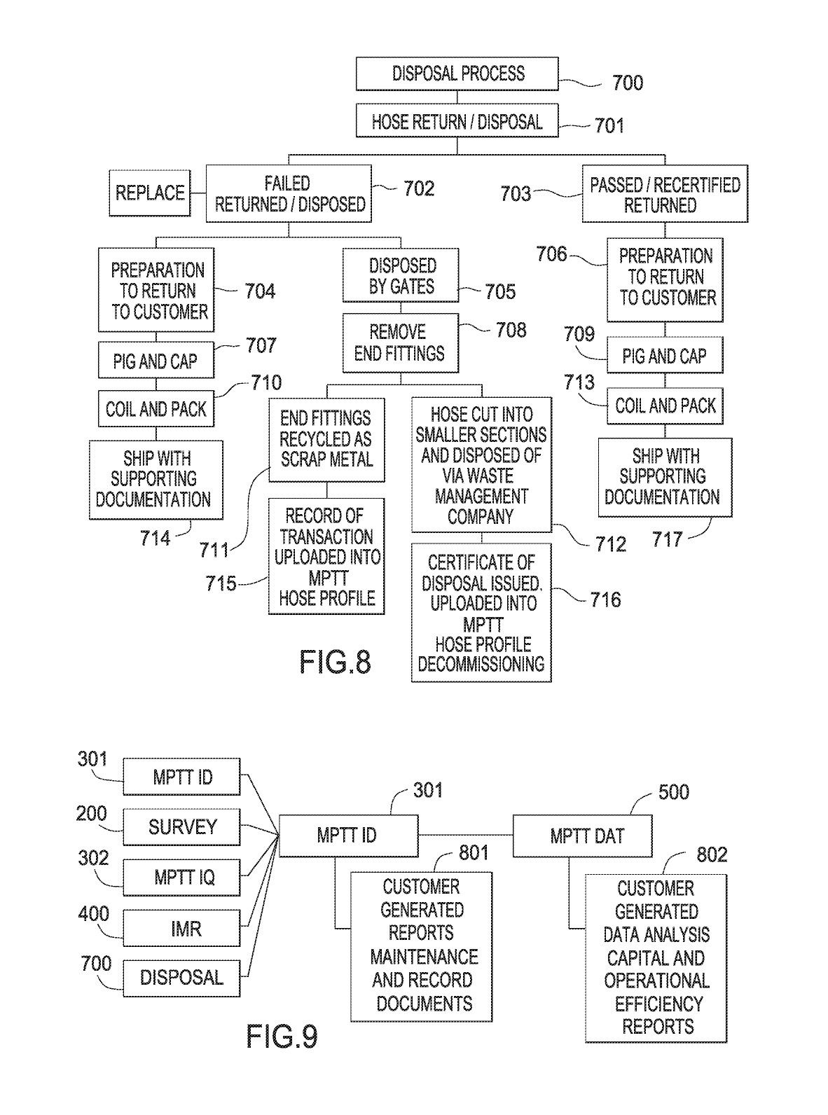

FIG. 7 is a chart identifying the rental process. Hose rental is available as an option to purchase. The process comprises two alternatives, in-service rentals on an as needed basis 601 and standby rentals 602. The in-service rental comprises individual hose assemblies rented for a contract period 603. Following completion of the contract period the hose assembly is returned 605. The contract period may range from days to months. Following return the hose assembly is tested and re-certified 608, 609. If the assembly fails it is disposed of 612, see FIG. 7. If it passes it is returned to the rental fleet 613.

For standby rentals 602, an inventory of stand by hose is provided on site in, for example, a container 604. A range of operating rated hoses are provided. For those hoses not used 606, they are returned to the central supplier office 610. Those hoses used on site 607 are invoiced 611 and sold to the customer.

The disposal process 700 comprises both return and disposal steps 701. If the returned hose fails the re-certification test 702, the hose is either returned to the customer 704 or disposed of by the contractor 705. If the hose is returned to the customer it is pigged, capped, coiled and packed 707, 710. It is then shipped with all supporting documentation 714 for disposal by the customer.

If the hose is disposed of by the contractor 705, end fittings are first removed 708. The end fittings are recycled 711 and a record is made in the system 715. The hose is cut into small pieces 712 and a certificate of disposal issues and uploaded into the system 716, see FIG. 9.

FIG. 9 is a chart identifying the information transfer. Information from the survey 200, MPTT 302, IMR 400 and disposal 700 are uploaded to MPTT 301. The MPTT information is used to generate customer reports 801. The MPTT ID information is also sent to the MPTT data analysis tool 500 which can then generate a customer generated analysis 802.

FIG. 10 is a screenshot of the data analysis tool user options. The data analysis tool comprises various report types. The report types are general 901, by region 902, by rig type 903, by rig 904 and by hose type 905. A report type may be selected by a user by clicking the appropriate icon. The system will then display the desired information and report on a visual output device such as a CRT, touch screen, flat panel, smartphone and so on.

The general reports 901 include operational efficiency 906, capital efficiency 907, performance evaluation 908, replacement schedule 909, trend analysis 910, financial analysis 911, incidents 912, time breakdown 913, operational 914, financial 915, engineering 916, and supply chain 917.

The region reports include North America 918, Central America 919, South America 920, North Sea 921, Europe 922, North Africa 923, West Africa 924, Middle East 925, Asia Pacific 926 and Australia.NZ.PNG 927 or other customer specified region(s). The noted regions are offered as examples only.

The rig type reports 903 include drillship 928, semi-submersible 929, jackup 930, barge 931, land 932, workover 933, and others 934. A “workover” rig may comprise any of those listed as it is a rig used to service a well completion that is no longer performing. The rig types listed are offered as examples only.

The rig reports 904 can be broken down by individual rig, for example, Rigs 1-4 935, 936, 937 and 938.

The hose type reports 905 include hydraulic 939, industrial 940, rotary 941, choke and kill 942, marine 943, transfer 944 and other 945. Industrial hose typically includes all hose not directly connected to the drilling operation, for example, compressed air, lube oil lines, dust suppression and so on. The report types listed are offered as examples only.

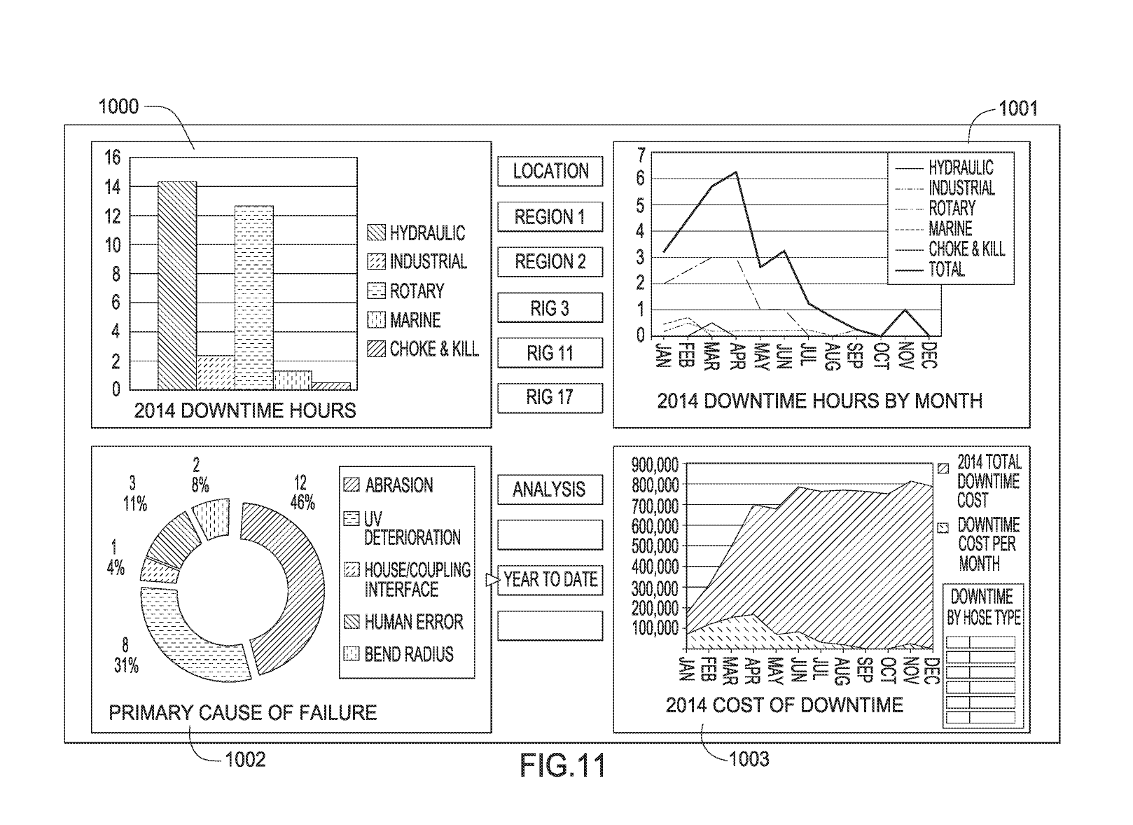

FIG. 11 is a screenshot of a flexible hose assembly downtime analysis. Downtime can be reported by hours and type of hose 1000. It can also be reported by month by type of hose 1001. It can also be reported by primary cause of failure 1002. Failure causes can include abrasion, UV deterioration, failure at the hose/coupling interface, human error, and damage form the hose being subjected to various factors that exceed the design parameters of the hose. Downtime cost can be reported by hose type 1003. The example report shown is for Region 2, Rig 17. The analysis may specify by month, year to date and versus budget.

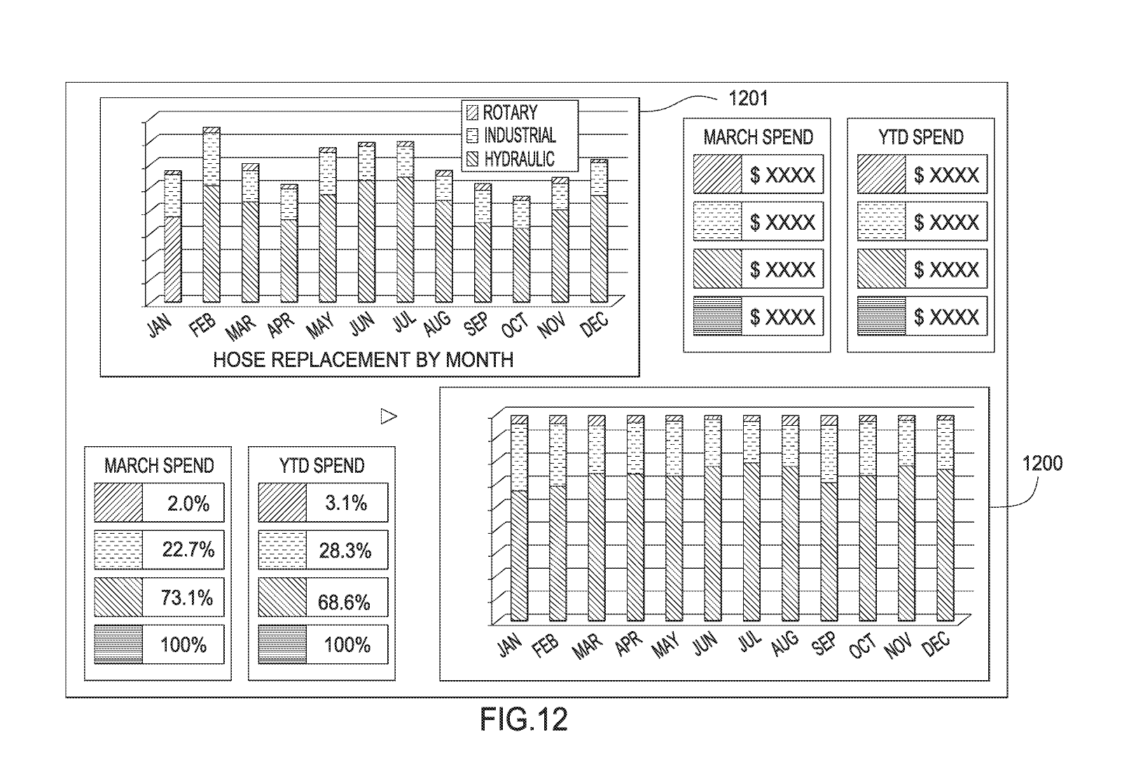

FIG. 12 is a screenshot of a flexible hose assembly replacement schedule. The replacement schedule can be depicted by number of hose types by month 1200. It can also be shown as hose type as a percentage of total by month 1201.

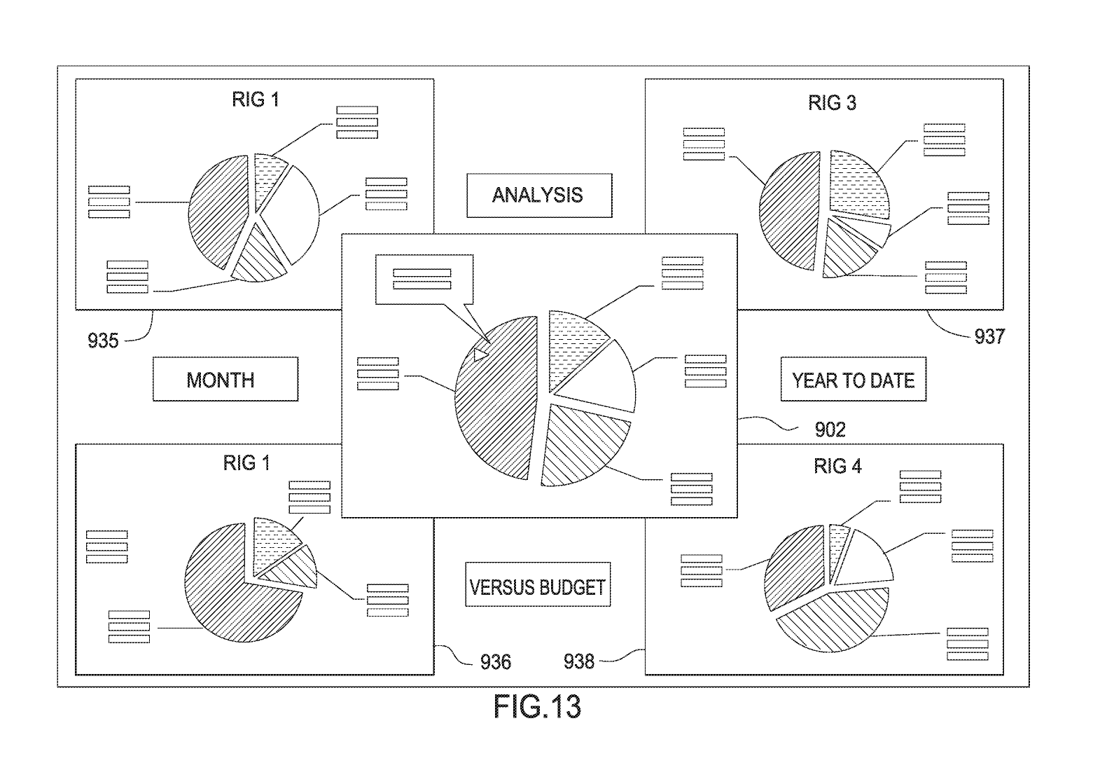

FIG. 13 is a screenshot of a flexible hose spend analysis. Region 1 is shown 902. Region comprises Rig 1 935, Rig 2 936, Rig 3 937, and Rig 4 938. Each graph for each rig shows percentage of spend by hose type. The analysis can proceed based upon month, year to date and versus budget. The region analysis 902 presents a cumulative average for all rigs in that region.

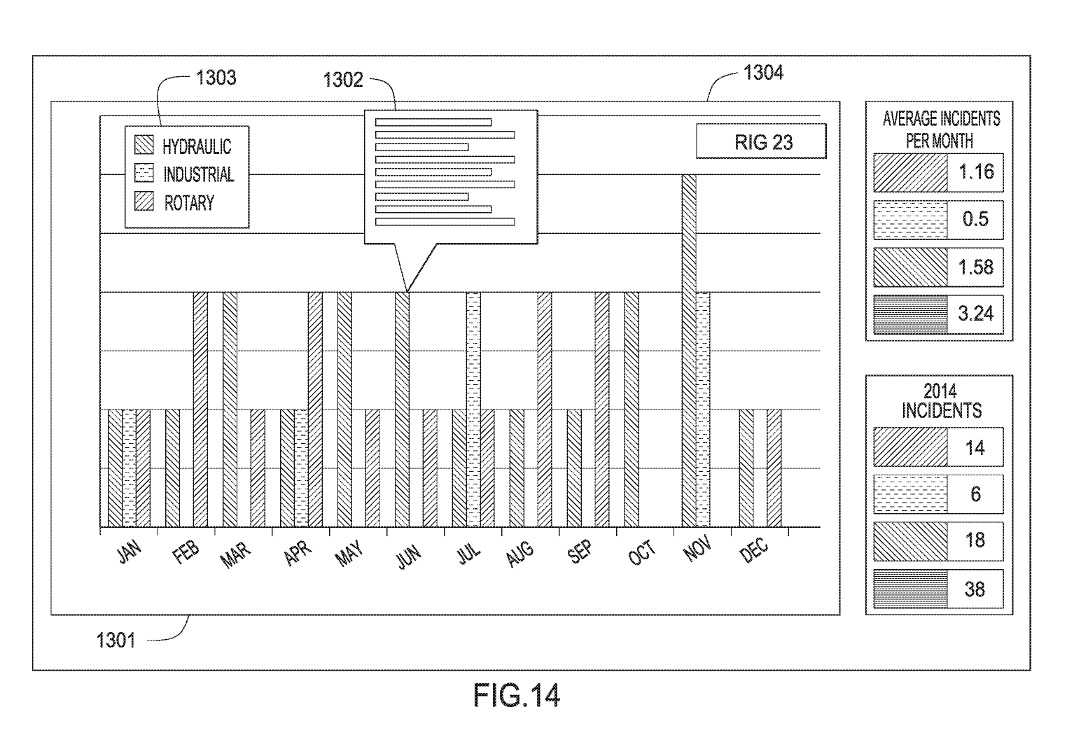

FIG. 14 is a screenshot of a flexible hose assembly incident analysis. The incident analysis 1301 includes a number, RFID number, date, time, location, affected equipment, spill, volume, and drill summary 1302. The analysis specified hose type 1303 and rig 1304.

FIG. 15 is a screenshot of the dashboard detail for a monitored product. Portion 1500 comprises multiple fields relating to various pieces of information about a given monitored product. The fields include equipment name, RFID number, print tag ID number, serial number, manufacturer, manufacturer model number, end (coupling) manufacturer (1 and 2: both ends), a brief description, hose size, hose type, working pressure in PSI, part number, overall length, and the location of the ends of the hose.

Portion 1501 links to each of the equipment fields including company (a), site (b), survey (c), location (d), equipment (e-g), asset detail (h, i) and photo (j).

The fields can be populated by a user, or may be automatically populated by electronic look up table, catalogue or other on-line source. For example, the manufacturer is entered by the user and the RFID scanned. Once scanned the system may access available databases to complete the remaining fields as required.

Company identifies the customer company. This includes by company the number of sites, number of locations, number of pieces of equipment, number of assets. The assets can be broken down by asset owner.

Site identifies the particular company facility. Site includes the site name, region, site type, locations, equipment, and assets.

Survey includes the information described in FIG. 2 item 200. Survey includes site name, job number, date created and description.

Location identifies the location of the equipment. Equipment location includes the location of the equipment at a given site, number of pieces of equipment. Equipment can be further broken down by numbers of particular types of equipment such as hose, tubing, couplings and so on.

Equipment identifies the particular piece of equipment. Equipment identifies the equipment, location, number of hoses for example and a click button to order a repair kit.

Asset detail identifies further information for the asset. For example, an assets detail screenshot is shown as portion 1500 of FIG. 15.

Photo is a repository for photos of the equipment or asset. The photos can be taken with a handheld device on site.

Portion 1502 provides a stop light (green/yellow/red) indication 1503 by hierarchy for multiple pieces of equipment by company (a), site (b), equipment location (c), equipment (d) and RFID number (d) or other unique identifier. Each light indication will provide the status of each piece of listed equipment. Each color of light will tell the viewer if the noted equipment requires further attention or is in an acceptable operating condition and status. For example, red indicates urgent attention needs to be paid to this piece of equipment. Yellow indicates attention needs to be given for inspection or to reorder a replacement. Green indicates the equipment is in good standing. An acceptable status or condition threshold is input by the user for the particular piece of equipment. Each of FIG. 10-15 is an example screenshot to be displayed on a flat screen, CRT, phone or other visual output display.

### Technical Description

A method for managing a monitored product life cycle comprising inputting a monitored product parameter into an operating system, selecting a monitored product compatible with the monitored product parameter from an inventory data base accessible by the operating system, assigning an identifier to the monitored product, assigning a user parameter to the monitored product whereby a status can be determined according to the user parameter, selecting a limit for the user parameter, fixing the identifier to the monitored product with an interrogatable device, detecting the identifier from the interrogatable device using a detector, transmitting the identifier to the operating system, detecting the user parameter and transmitting it to the operating system, and reporting to a user a life cycle status using the identifier and the user parameter.

The method wherein the supplier operating system comprises a handheld interface.

The method wherein the identifier is selected according to an algorithm comprising type, media, location and install date.

The method wherein the monitored product is a fluid conduit.

The method wherein monitored product parameters may be selected by a user from the group comprising visual survey, registration, inspection, maintenance, recertification, flushing, rental, disposal.

The method wherein the supplier operating system will report for a monitored product to a user on a topic selected from the group comprising life cycle documentation comprising a certificate of conformance, certificate of hydrostatic test, test graphs, inspection documentation, order processing documentation comprising a quote, purchase order, delivery ticket, returned ticket, and transportation document, predesign and install hazard analysis, commission and install record, and incident and failure documentation including root cause analysis and tap root report and investigation report.

The method wherein the supplier operating system will report for a monitored product to a user on a financial topic selected from the group comprising total cost of ownership, cost of down time, month and year to date spend.

The method wherein the supplier operating system is accessible by a customer operating system.

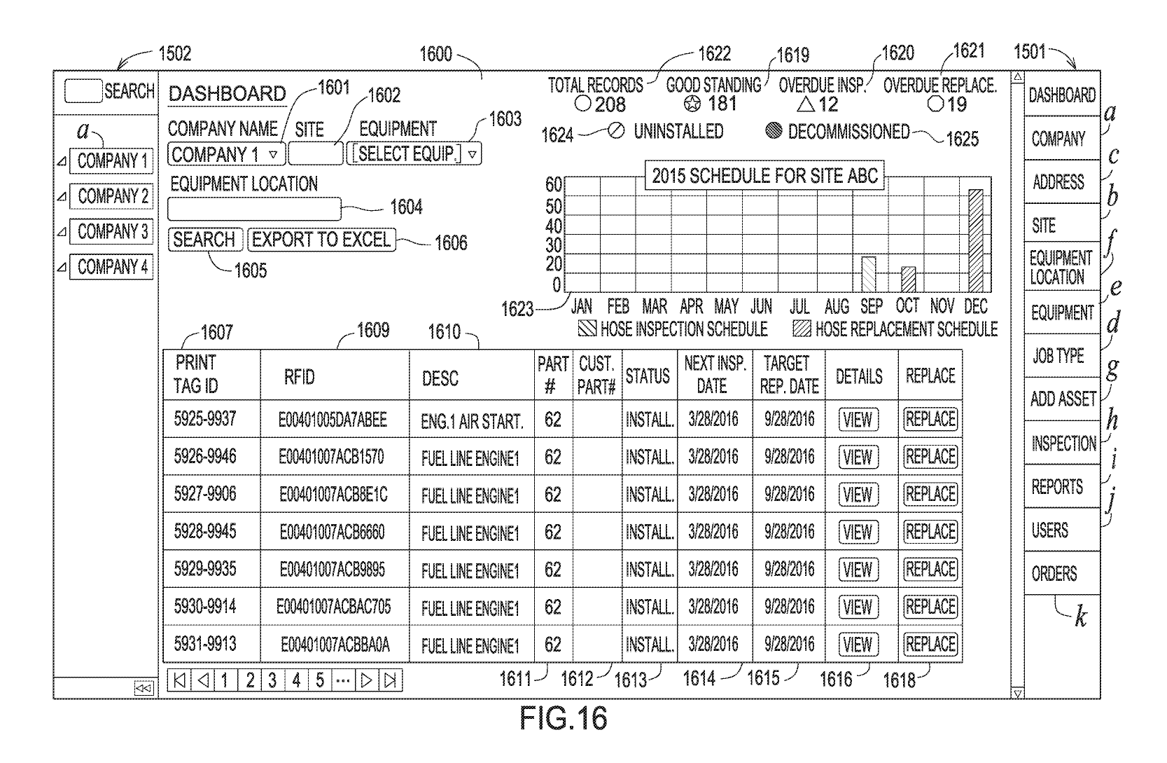

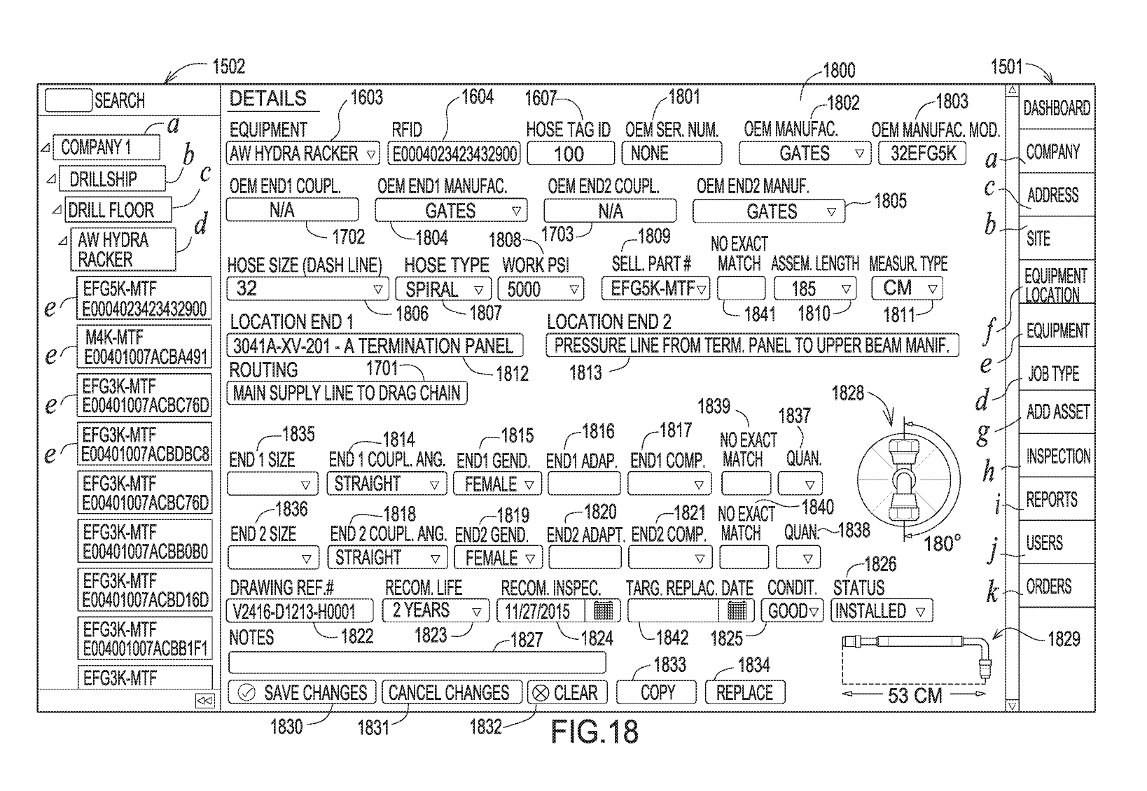

FIG. 16 is a screenshot of the dashboard detail for a monitored product. A customer company is selected in portion 1502a. The company name is selected in field 1601. Site information is selected in field 1602. Site information may include any site having a rig or rigs depending on how this is broken down by the company. The equipment 1603 is then selected at the given site. Equipment location information is displayed in window 1604 for the selected equipment 1603. A record search function is also included 1605. The search function can covers fields 1601, 1602, 1603, 1604. Fields 1601, 1602, 1603 can be requested by an authorized user. The data then auto-populates the graph 1622. Table 1607 to 1618 auto-populates in the same manner when icon 1619 to 1622 is selected. A authorized user can “surf” companies by identifying them in the company name field which is a drop down box. Once identified, the screen 1600 will auto refresh and show the company name as well as the data navigation tabs in portion 1502 see FIG. 18. Once the company name is selected a user can then choose the “site” 1602 the drop down box of all sites set up for that company name. The sites are identified from the site Menu Tab.

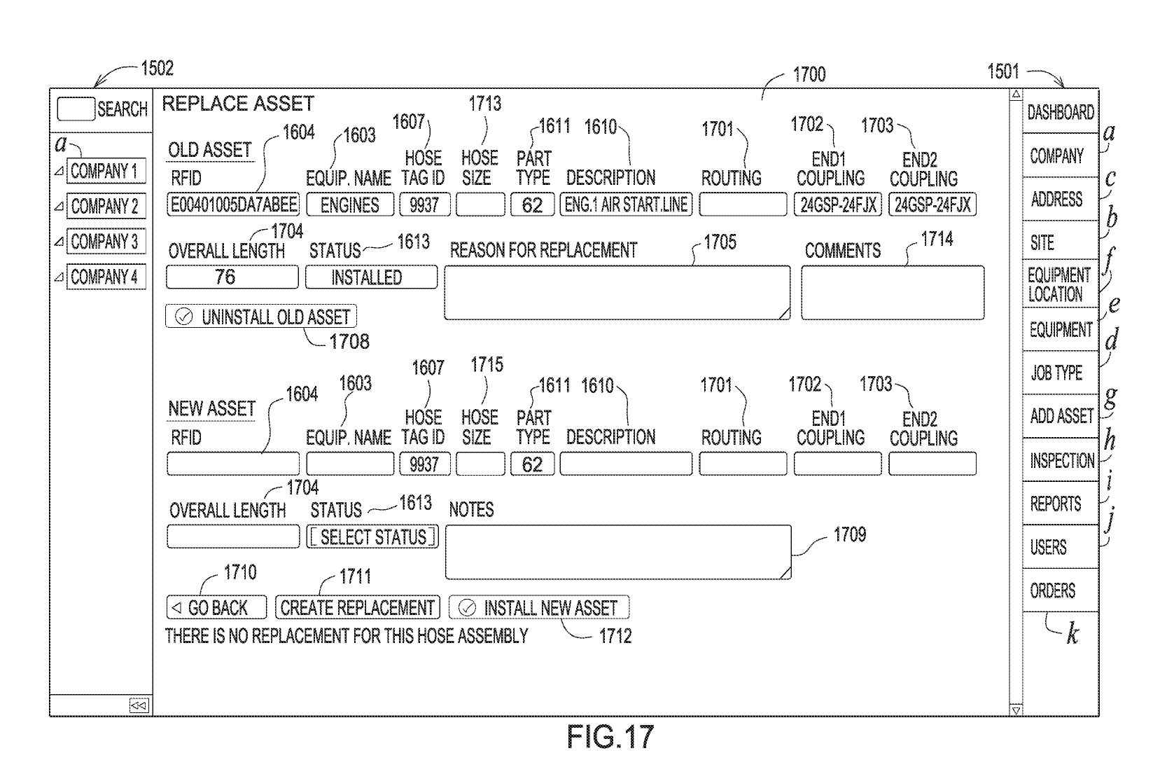

Company screens and related fields in portion 1502 are auto-populated via from data entered on portion 1501. Authorized users can update information from these screens. Portion 1501 is primary data entry. Data relating to each tab is input by an authorized user. The displayed file(s) can be exported to Excel® using known methods 1606. Relevant equipment information includes RFID tag ID 1607, RFID number 1609, equipment description 1610, part number 1611, customer part number 1612, equipment status 1613, next inspection date 1614, target replacement date 1615, details 1616, and replace 1618. These fields can be completed for each RFID number 1604. Clicking on details 1616 takes the user to screen 1800, see FIG. 18. Clicking on replace 1618 takes the user to screen 1700, see FIG. 17.

Total Records meter 1622 indicates the number of equipment records for the identified company 1601. Good Standing meter 1619 indicates the number of pieces of equipment not requiring any action. The equipment is in the table 1607 through 1618. Good standing is also indicated by a star as positive reinforcement. Overdue Inspection meter 1620 indicates the number of pieces of equipment for which an inspection is overdue. This is depicted by a triangle as a warning. Overdue replacement meter 1621 indicates the number of pieces of equipment for which replacement is overdue. Overdue replacement is depicted by a stop sign image to further encourage replacement.

Graphic 1623 charts the hose inspection schedule and equipment replacement schedule for the noted company 1601 and a particular site 1602. This is established by customer policy, a manufacturers recommended replacement schedule, or industry guidelines or a combination of the foregoing. The y-axis is the number of pieces and the x-axis is by month. Information from fields 1614 and 1615 for all pieces of equipment are used by the system to produce chart 1623. This chart 1623 provides a quick snapshot of equipment activities over a given year, or, customer designated time frame. The chart can either look forward or backward. Hovering a mouse over a specific month of the chart 1623 will show the total number of hoses due for inspection or replacement during that month. However, the table 1607-1618 will update the hoses (components) needing inspection or replacement beginning with the oldest asset requiring attention. This eliminates the ability to delete, or fail to replace or inspect the hose. The only way that a user can remove a hose (component) from the table is to change the Inspection/Replacement date, actually inspect or replace it. If that is done, a time and identification stamp identifies the individual who has made the change accordingly and asks for a comment as to why the change was made. Replace 1618 can include decommissioning or uninstall. Decommissioning means the component is no longer available for use and is thereafter disposed of. Uninstall means the component is removed but is still available for service such as in a transfer to another rig or when used as a temporary replacement. The reason for replacement should also be recorded.

Column 1501 includes the following clickable tabs; company 1501a, address 1501c, site 1501b, job type 1501d, equipment location 1501f, equipment 1501e, add asset 1501g, inspection 1501h, reports 1501i, users 1501j, orders 1501k.

Address 1501c is the company address. Site 1501b refers to 1602 and is broken down by individual sites for the company. The sites may be a rig, facility, vessel, region or location. Job type 1501d refers to job type which may include a rig survey, visual inspection, rig audit, boroscope, mobile crimping, pipe flushing, rental or other jobs. Equipment location 1501f refers to the physical location of the equipment on the site, for example, drill floor, pipe deck, derrick, shaft head and so on. Equipment 1501e refers to 1603 and identifies information of the particular piece of equipment. Equipment manufacturer and model number can also be included.

Add asset 1501g refers to screen 1800. Inspection 1501h refers to the manner and type of inspection required for a given piece of equipment. Reports 1501i refers to reports that can be generated by the system including inspection, replacement, order status. These can be further broken down by asset type, location, company, site, pressure rating, temperature rating and so on.

Users 1501j is for adding users and limited to administrator users per region. The customer, regardless of user status only has access to their company's data. User access is permission granted as established by the customer within that company. The amount of information each customer user is allowed access to is permission based.

Order 1501k refers to all pending orders and the current status of each. When ordering parts, individually or by kits, the process is the same as ordering online; the user fills the shopping cart and then the order is placed. Table 1607 to 1618 captures orders in process and orders placed. As a vendor proceeds with building the order it assigns an RFID Number 1609 and updates the order/Hose Status field. Once entered into the system the user will have access to the information. Orders are searchable by company, region (all sites) or a single site per user authorization. Orders are also searchable by equipment, product types, or inspections or, by a single RFID. The results can be exported to Excel if required.

Fields 1601, 1602, 1603, 1604, are completed by a user. The system populates fields 1607 through 1615. Each meter 1619 to 1622 is generated by the software using the user inputs.

FIG. 17 is a screenshot of the asset replacement screen. Screen 1700 is broken up into two portions, “Old Asset” and “New Asset”.

As to the Old Asset portion, clicking on replace column 1618 in FIG. 16 brings up screen 1700. Screen 1700 includes certain fields as described in FIG. 18. Screen 1700 also identifies routing field 1701. Routing 1701 describes how the particular piece of equipment is routed (installed) in the customer system. End1 coupling 1702 and end2 coupling 1703 describes the coupling at each end of the equipment (hose). Overall length field 1704 describes the length of the equipment (hose). Status field 1613 indicates the status of the equipment, for example, scheduled replacement, damaged, returned to inventory and so on. Reason for replacement 1705 allows a user to input the reason(s) the equipment was replaced, for example, worn out, damaged, design life exceeded and so on. Uninstall old asset field 1708 allows a user to indicate if the existing asset should be removed from the rig or system. A user clicks yes or no for this input. The Old Asset portion is auto-populated from data entered via portion 1501.

As to the New Asset portion, each of the fields is as described for the Old Asset, except the information relates to the New Asset. Notes 1709 includes any notes input by a user deemed relevant to the new asset. Go Back 1710 returns to the prior screen. Create replacement 1711 allows a user to identify a replacement piece of equipment for the new asset, including by model number, manufacturer and so on. A “there is no replacement for this hose assembly” message will appear, for example, if a replacement assembly is not available for a given application.

Install new asset 1712 lodges an instruction to install the new asset. The appropriate work crew is then tasked to install the new asset, and the old asset is recorded in the History as the previous asset to the new asset.

If a New Asset is different from the Old Asset, a Reason for Change inquiry will occur. The program will also record who was logged in to make the change and at what time. This information can be retrieved as needed. The Reason for Change will include dropdowns such as scheduled or unscheduled replacement, damaged, equipment change and so on.

Fields 1603, 1604, 1607, 1611, 1610, 1701, 1702, 1703, 1704, and 1613 for the Old Asset are populated by the system. The same fields for the New Asset are populated by the user.

FIG. 18 is a screenshot of the asset detail page. Referring also to FIG. 15, screen 1800 includes certain fields as described in FIG. 16 and FIG. 17. This screen provides further detail for the equipment, for example, in fields 1502d, 1603 and 1501e. 1502e includes seller part number 1809 and RFID number 1604. The fields in screen portion 1800 are where data is entered for the noted fields by an authorized user. These fields are also updated from this screen 1800. Portion 1502 can also be used for secondary data entry for the noted fields, for example, data relating to the individual components or products.

Portion 1502 is the data information side of the screen. The data information side provides data relating to the particular customer, company or application. It includes details such as company 1502a, rig or facility 1502b, location in the rig or facility 1502c, specific piece of equipment 1502d, and individual component 1502e. The 1502 data is entered in 1501 and thereafter populates 1502. Each customer company may only access information relating to that company and no others.

Portion 1501 is the menu side of the screen. The menu side comprises the information of interest to a user by category. For example, company name 1501a, company address 1501c, drill site 1501b, job type 1501d, equipment location 1501f, equipment description 1501e. A user can add an assets 1501g, or access data relating to equipment inspection 1501h, generate reports 1501i, identify users 1501j and review orders for products 1501k. This portion 1501 is accessible by system administrators. The menu items can be accessed sequentially in a descending manner from top to bottom of the list.

Serial number 1801 contains the serial number for the original equipment manufacturer (OEM) in 1603. Manufacturer 1802 lists the manufacturer of the equipment. Manufacturer model 1803 contains the model number. End1 manufacturer 1804 identifies the manufacturer of the end connector. End2 manufacturer 1805 identifies the manufacturer of the end connector.

Hose size 1806 describes the hose diameter. Hose type 1807 identifies the hose type. Work PSI 1808 describes the working pressure of the hose. Seller part number 1809 describes the seller part number of the equipment in 1610. Assembly length 1810 describes the length the equipment assembly in 1603. Measure Type 1811 lists the units (metric or imperial) in 1806.

Location end1 1812 lists the location of the end of the equipment in 1603. Location end2 1813 lists the location of the other end of the equipment in 1603.

End1 coupling angle 1814 identifies the angle of coupling 1 1702. End1 gender 1815 lists the male/female gender of the coupling 1702. End1 adaptor 1816 lists whether an adaptor is required for coupling 1702. End1 component 1817 lists any other components associated with coupling 1702. End1 size 1835 identifies the size of the coupling. Quantity 1837 lists the quantity of End 1. No exact match 1839 indicates whether a matching component is available.

End2 coupling angle 1818 identifies the angle of coupling 2 1703. End2 gender 1819 lists the male/female gender of the coupling 1703. End2 adaptor 1820 lists whether an adaptor is required for coupling 1703. End2 component 1821 lists any other components associated with coupling 1703. End2 size 1836 identifies the size of the coupling. Quantity 1838 lists the quantity of end2. No exact match 1840 indicates whether a matching component is available.

Drawing Ref number 1822 refers to the drawing of the equipment 1603. Recommended life 1823 lists the recommend life before replacement of the equipment 1603. Recommended inspection 1824 lists the time interval for the next inspection of the equipment identified by RFID tag in 1604 for the equipment 1603. This would be either a customer policy, vendor policy or industry policy. The inspection could include visual, re-test/re-certify or other as may be required. Condition 1825 lists the condition of the equipment 1604. Status 1826 indicates the equipment in 1604 status, which may include any relevant indication including installed, removed, inspected, failed, and so on.

Each field which includes a down arrow depicts a drop down table. Each drop down table comprises a list of available terms that relate to that field. For example, end1 manufacturer 1804 will include a list of coupling manufacturers known in the industry. Field End 1 gender 1815 will be either male or female. Recommended life 1823 will reflect a certain time frame in years or months. Fields 1814 and 1818 will be noted in degrees.

Notes 1827 is a field to be completed by a user to include any further information relevant to the equipment 1603 or any other fields on the screen. Graphic 1828 is a depiction of the described equipment identified by RFID tag in 1604. Graphic 1828 indicates orientation of the couplings to reduce questions and to eliminate errors in the field during installation. Graphic 1829 is a description of the equipment shown in 1828 and 1604. Graphic 1829 ensures the equipment (hose) is identified correctly, reordered, built, inspected, shipped and is the correct hose received for installation. This reduces mistakes among the market channel and for installation.

Button 1830 saves changes to the fields on screen 1800. Button 1831 cancels changes to the fields on screen 1800. Button 1832 clears the fields on screen 1800.

The fields in screen 1800 can either be populated by the system or the user. Information to populate the fields can be obtained by the system, for example, from portion 1502e.

Screen 1800 is divided into a data information portion on a left side 1502, a menu portion on a right side 1501 and a data entry portion 1800 between the data information portion and the menu portion.

Although forms of the invention have been described herein, it will be obvious to those skilled in the art that variations may be made in the construction and relation of parts and method without departing from the spirit and scope of the invention described herein.

We claim:

1. A method for managing a monitored product life cycle comprising:
inputting a monitored product parameter into an operating system;
selecting a monitored product compatible with the monitored product parameter from an inventory data base accessible by the operating system;
assigning an identifier to the monitored product;
assigning a user parameter to the monitored product whereby a status can be determined according to the user parameter;
selecting a limit for the user parameter;
fixing the identifier to the monitored product with an interrogatable device;
detecting the identifier from the interrogatable device using a detector;
transmitting the identifier to the operating system;
detecting the user parameter and transmitting it to the operating system; and
reporting to a user a life cycle status using the identifier and the user parameter.

2. The method as in claim 1, wherein the supplier operating system comprises a handheld electronic interface.

3. The method as in claim 1, wherein the identifier is selected according to an algorithm comprising type, media, location and install date of the monitored product.

4. The method as in claim 1, wherein the monitored product is a fluid conduit.

5. The method as in claim 1, wherein monitored product parameters may be selected by a user from the group comprising visual survey, registration, inspection, maintenance, recertification, flushing, rental, and disposal.

6. The method as in claim 1, wherein the operating system will report for a monitored product to a user on a topic selected from the group comprising:
life cycle documentation comprising a certificate of conformance, certificate of hydrostatic test, test graphs, inspection documentation, order processing documentation comprising a quote, purchase order, delivery ticket, returned ticket, and transportation document, predesign and install hazard analysis, commission and install record, and incident and failure documentation including root cause analysis and tap root report and investigation report.

7. The method as in claim 1, wherein the operating system will calculate and report for a monitored product to a user on a financial topic selected from the group comprising total cost of ownership, cost of down time, month and year to date spend.

8. The method as in claim 1, wherein the operating system is accessible by a customer computer operating system.

9. The method as in claim 1, wherein the operating system presents a diagram indicative of the configuration of the monitored product comprising as diagram of the orientation of the monitored product couplings.

10. The method as in claim 1 comprising reporting an output on a user screen wherein the screen is divided into a data information portion on a left side, a menu portion on a right side and a data entry portion between the data information portion and the menu portion.

11. The method as in claim 10, wherein the data information portion is used by a user to input data to identify a product user.

12. The method as in claim 10, wherein the menu portion is used to select customer attributes relating to a product.

13. The method as in claim 12, wherein the data entry portion comprises fields by which a user inputs information relating to a product.

14. The method as in claim 10 comprising displaying a chart representing product data.

15. The method as in claim 10, wherein the data entry portion comprises visually depicting a product.
